(19) United States
(12) Patent Application Publication
(10) Pub. No.: US 2015/0136093 A1
(43) Pub. Date: May 21, 2015

(54) Engine Boosting System and Method Therefor

(71) Applicant: Perkins Engines Company Limited, Cambridgeshire (GB)

(72) Inventor: Paul Moore, Cambridgeshire (GB)

(73) Assignee: Perkins Engines Company Limited, Cambridgeshire (GB)

(21) Appl. No.: 14/398,613

(22) PCT Filed: May 24, 2013
(86) PCT No.: PCT/GB2013/051388

§ 371 Date: Nov. 3, 2014

(30) Foreign Application Priority Data
May 25, 2012 (GB) 12169633.0

(51) Int. Cl. F02M 25/07

(52) U.S. Cl. CPC F02M 25/072; F02M 25/0706; F02M 25/0727
USPC 123/568.12; 123/568.11

(57) ABSTRACT

The engine boosting system includes an engine having an intake manifold, exhaust manifold and exhaust gas recirculation loop fluidly connected therebetween. A boost circuit including a storage vessel is in fluid communication with the intake manifold and with the exhaust manifold. A throttle is located downstream of the exhaust manifold, the exhaust gas recirculation loop, and the boost circuit. A connection between the boost circuit and the intake manifold is independent of a connection between the exhaust gas recirculation loop and the intake manifold.

### TECHNICAL FIELD

This disclosure is directed to an engine boosting system and a method therefor, and in particular to an engine boosting system for use with turbocharged internal combustion engines.

### BACKGROUND

Turbochargers are typically used with internal combustion engines, such as diesel engines, in order to maximise the power available therefrom. Other benefits of turbocharged engines include greater fuel efficiency and lower emissions relative to a naturally aspirated engine of similar power.

A common problem associated with turbocharged engines is that the power, fuel efficiency, and emissions-control performance are reduced during transient conditions. Transient conditions occur, for example, under a rapidly increasing or decreasing engine load. Under a rapidly increasing engine load, a turbocharger compressor may require increased torque in order to deliver an increased air flow, but such increased torque may not be available if a turbine driving the compressor is not fully spun-up. This may result in a power lag until the intake air flow increases to the requisite level.

Known turbocharged engines use accumulators to allow normally wasted energy during engine overrun or braking operating conditions to be recovered in the form of compressed air. During such operating conditions, the engine continues to turn over but no fuel is injected into the cylinders; this causes the cylinders to operate as air pumps, resulting in the compression of ambient air in the cylinders (without the addition of fuel). The compressed air is stored in the accumulator, which can then be utilised to assist the turbomachinery in developing boost at low engine speed/load conditions.

U.S. Pat. No. 7,367,327 discloses a method and device for boosting an intake pipe of a turbocharged engine with compressed gas. Gases are stored in a vessel at a pressure greater than atmospheric pressure, and afterwards injected into the intake pipe in order to temporarily increase an inlet pressure during low-speed operation phases. The device includes a connection for temporarily and alternately connecting the storage vessel to an exhaust manifold for recovering the gases during engine brake phases or to the intake pipe during the temporary low-speed operation phases.

U.S. Pat. No. 8,069,665 discloses a method for providing air to a combustion chamber of an engine, the engine including a compressor and a boost tank selectably coupled to an intake manifold. The method includes varying a relative amount of engine exhaust in air pressurised in the boost tank based on engine operating conditions, and discharging the air pressurised in the boost tank to the intake manifold.

### SUMMARY

According to a first aspect of the present disclosure there is provided an engine boosting system comprising: an engine having an intake manifold, an exhaust manifold, and an exhaust gas recirculation loop fluidly connected therebetween; a boost circuit in fluid communication with the intake manifold and with the exhaust manifold, the boost circuit comprising a storage vessel; and a throttle located downstream of the exhaust manifold, the exhaust gas recirculation loop, and the boost circuit; wherein a connection between the boost circuit and the intake manifold is independent of a connection between the exhaust gas recirculation loop and the intake manifold.

According to a second aspect of the present disclosure there is provided a method for boosting an intake of an internal combustion engine, said engine comprising an intake manifold, an exhaust manifold, and an exhaust line fluidly connected to the exhaust manifold, the method comprising the steps of: (a) pressuring gas in the exhaust line and storing the pressurised gases in a storage vessel; and (b) discharging pressurised gas from the storage vessel into the intake manifold.

One exemplary embodiment of an engine boosting system is as described with reference to, and as shown in the accompanying drawings.

### BRIEF DESCRIPTION OF THE DRAWINGS

FIG. 1 is a schematic of an engine boosting system according to the present disclosure; and

FIG. 2 is a schematic of a control system for the engine boosting system of FIG. 1.

### DETAILED DESCRIPTION

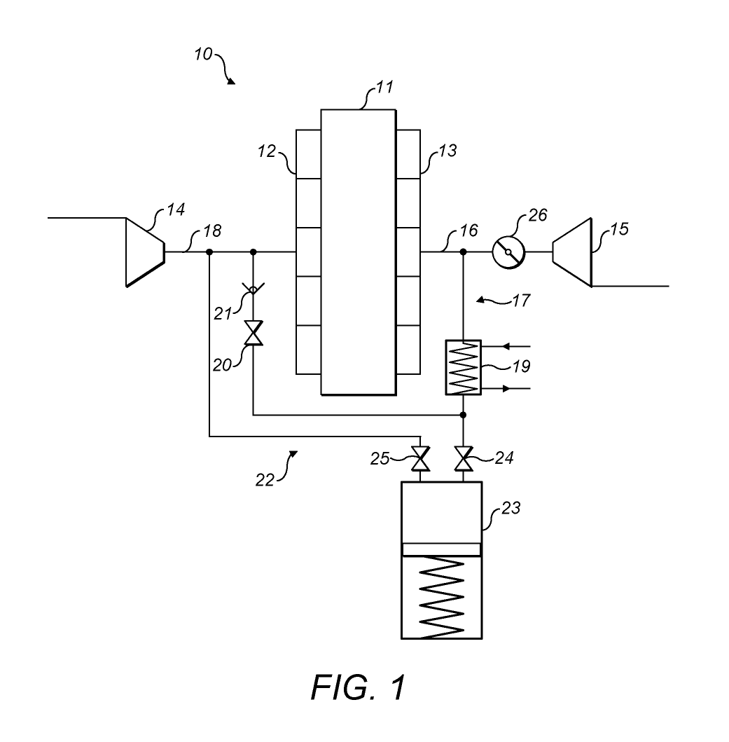

FIG. 1 illustrates an engine boosting system 10 for an engine 11, which may be an internal combustion engine, such as a diesel engine, having an intake manifold 12 and an exhaust manifold 13. As is typical in the field, the engine 11 comprises a plurality of cylinders comprising combustion chambers (not shown). This arrangement enables the intake of the engine 11 to be boosted via a compressor 14. The compressor 14 is fluidly connected to the intake manifold 12 by intake line 18 and may also be mechanically coupled (not shown) to a turbine 15. The turbine 15 may be driven by exhaust gases exiting the exhaust manifold 13 through an exhaust line 16, which may be fluidly coupled to the exhaust manifold 13 and extend therefrom. Alternatively, the engine 11 may be boosted by other compression means, such as a supercharger. A throttle 26 may be provided in the exhaust line 16, either upstream or downstream of the turbine 15. A wastegate (not shown) may be provided so that the exhaust may be directed to bypass the turbine 15 when reduced torque is desired.

The engine boosting system 10 has an exhaust gas recirculation (EGR) loop 17, which is fluidly connected to the exhaust line 16 between the exhaust manifold 13 and the turbine 15. The EGR loop 17 is also fluidly connected to the intake line 18 between the compressor 14 and the intake manifold 12. The EGR loop 17 may include a cooler 19 for cooling the exhaust gases prior to their inclusion in the intake gases. The cooler 19 may, for example, be an air-to-air or air-to-water heat exchanger. The EGR loop 17 may be controlled via an EGR control valve 20. A non-return valve 21 may be provided in the EGR loop 17 to prevent the passage of intake gases into the EGR loop 17.

The engine boosting system 10 also has a boost circuit 22, which is fluidly connected to the exhaust line 16 between the exhaust manifold 13 and the turbine 15. The boost circuit 22 is also fluidly connected to the intake line 18 between the compressor 14 and the intake manifold 12. The connection between the boost circuit 22 and the intake manifold 12 may be independent of the connection between the EGR loop 17 and the intake manifold 12. The boost circuit 22 may be directly connected to the exhaust line 16. Alternatively, it may be connected to the exhaust line 16 via the EGR loop 17, downstream of the cooler 19 (as shown in FIG. 1). In this configuration, a single cooler 19 may be used in both the EGR loop 17 and the boost circuit 22. Alternatively, the boost circuit 22 may be completely independent of the EGR loop 17 and may include a second cooler 19 (not shown).

The boost circuit 22 includes a storage vessel 23. The storage vessel 23 may be any type of reservoir of a suitable size and configured to store compressed air under pressure for later discharge. The storage vessel 23 may be an accumulator, such as a pneumatic accumulator. First and second control valves 24,25 may be provided respectively at an inlet and an outlet of the storage vessel 23, to control flow both into, and out of, the storage vessel 23.

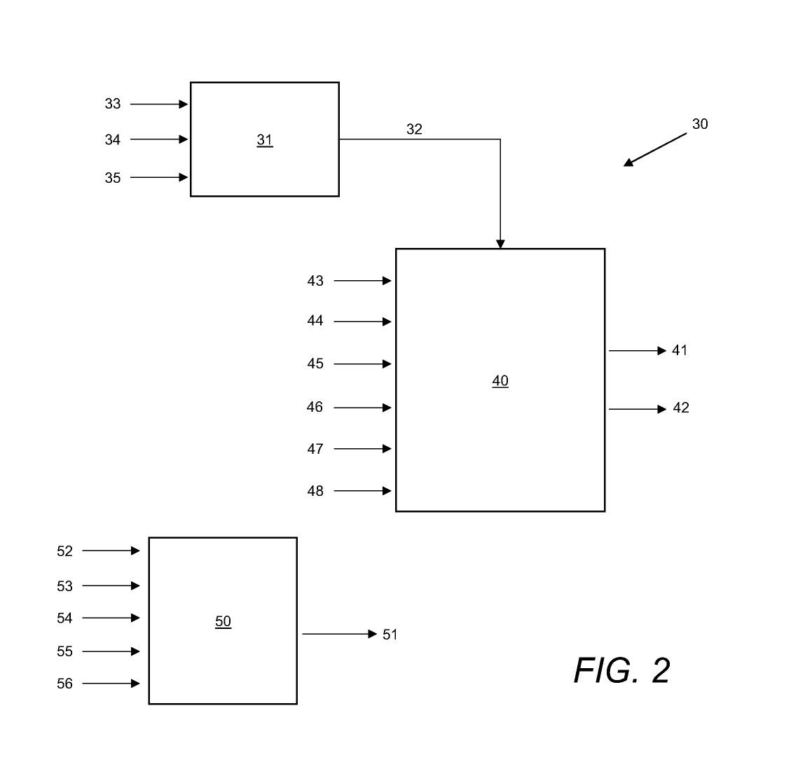

FIG. 2 shows a schematic of an exemplary control system 30 that may be used to control the engine boosting system 10. Boost recovery mode selection 31 may be enabled/disabled 32 dependent on the desired engine speed 33, the actual engine speed 34, and the fuel delivery 35. If the boost recovery mode selection 31 is enabled, the boost recovery exhaust throttle controller 40 may determine the desired position of the throttle 41 (%) and the accumulator inlet valve position 42 (%). This determination may be based on inputs relating to the actual position of the throttle 43, the target 44 and maximum 45 exhaust pressures as determined by an exhaust pressure sensor 46, and the minimum 47 and maximum 48 throttle positions. Separately, a boost recovery accumulator controller 50 may determine the position of the accumulator outlet valve 51 based on inputs relating to the turbocharger speed 52, the desired 53 and actual 54 inlet manifold air pressure (IMAP), the exhaust gas recirculation mass flow 55, and the fuel delivery 56.

### INDUSTRIAL APPLICABILITY

The engine boosting system 10 has industrial applicability in the field of engines, and in particular internal combustion engines, and may be used on a variety of different internal combustion engines, such as diesel engines. The engine boosting system 10 is particularly suited to be applied to boosted engines, such as engines including turbochargers.

During, for example, engine braking or overrun conditions, the engine 11 may continue to turn over but no fuel may be injected into the cylinders; this may cause the cylinders to operate as gas pumps, resulting in the compression of gas, such as air, inside the cylinders. At the same time, the throttle 26, the EGR control valve 20, and the second (outlet) control valve 25 may close, whilst the first (inlet) control valve 24 may open. This may cause the compressed gas (air) from the cylinders to pressurise the exhaust manifold 13 and the exhaust line 16. The positioning of the first and second control valves 24,25 and the back pressure in the exhaust manifold 13 and the exhaust line 16 may cause the storage vessel 23 to fill with compressed gas (fresh air).

When engine braking/overrun conditions finish, the first (inlet) control valve 24 may close and the throttle 26 may open. The engine 11 and EGR loop 17 may function normally in this configuration.

During periods of boost limited operation, for example transient and low speed conditions, the amount of intake gas available from the compressor 14 may be inadequate. In such situations, the second (outlet) control valve 25 may open and may allow the pressurised gas stored in the storage vessel 23 to feed into the intake manifold 12, thereby assisting the compressor 14 in developing boost. Pressurised exhaust gases may additionally and simultaneously be fed into the intake manifold 12 through the EGR loop 17.

The engine boosting system 10 enables the capture of normally wasted energy during engine overrun or braking conditions and uses it to develop pressurised gas (air) to assist in boosting the engine 11. This may help in overcoming the performance problems caused by downsizing and downspeeding internal combustion engines, which is considered as an effective way of increasing engine efficiency.

1. An engine boosting system comprising:
an engine having an intake manifold, an exhaust manifold, and an exhaust gas recirculation loop fluidly connected therebetween;
a boost circuit in fluid communication with the intake manifold and with the exhaust manifold, the boost circuit comprising a storage vessel; and
a throttle located downstream of the exhaust manifold, the exhaust gas recirculation loop, and the boost circuit; wherein
a connection between the boost circuit and the intake manifold is independent of a connection between the exhaust gas recirculation loop and the intake manifold.

2. An engine boosting system according to claim 1, further comprising an exhaust line extending from the exhaust manifold, wherein the throttle is located in the exhaust line, and wherein the exhaust gas recirculation loop and the boost circuit are fluidly connected to the exhaust line upstream of the throttle.

3. An engine boosting system according to claim 1, further comprising a control system for controlling the operation of the boost circuit and the throttle.

4. An engine boosting system according to claim 1, further comprising a cooler operable to cool exhaust gases in the exhaust gas recirculation loop.

5. An engine boosting system according to claim 1, further comprising a cooler operable to cool gases in the boost circuit.

6. An engine boosting system according to claim 1, wherein a first control valve is provided at an inlet to the storage vessel and a second control valve is provided at an outlet from the storage vessel.

7. An engine boosting system according to claim 1, wherein the exhaust gas recirculation loop comprises a control valve.

8. An engine boosting system according to claim 1, wherein the exhaust gas recirculation loop comprises a non-return valve.

9. An internal combustion engine comprising an engine boosting system according to claim 1.

10. A method for boosting an intake of an internal combustion engine, said engine comprising an intake manifold, an exhaust manifold, and an exhaust line fluidly connected to the exhaust manifold, the method comprising the steps of:
(a) pressuring gas in the exhaust line and storing the pressurised gases in a storage vessel; and
(b) discharging pressurised gas from the storage vessel into the intake manifold.

11. A method according to claim 10, wherein the internal combustion engine further comprises an exhaust gas recirculation loop, and wherein during step (b) the exhaust gas recirculation loop is operable to feed pressurised exhaust gases into the intake manifold.

12. A method according to claim 10, wherein steps (a) and (b) operate simultaneously.

13. A method according to claim 10, wherein during step (a) the internal combustion engine runs without injection of fuel such that fresh air is discharged into the exhaust line.

14. A method according to claim 10, wherein in step (a) the pressurised pressurized exhaust gases are cooled prior to storage.

15. A method according to claim 10, wherein the internal combustion engine is an engine according to having an intake manifold, an exhaust manifold, and an exhaust gas recirculation loop fluidly connected therebetween.

16. An engine boosting system according to claim 2, further comprising a control system for controlling the operation of the boost circuit and the throttle.

17. An engine boosting system according to claim 17, further comprising a cooler operable to cool exhaust gases in the exhaust gas recirculation loop.

18. An engine boosting system according to claim 2, further comprising a cooler operable to cool exhaust gases in the exhaust gas recirculation loop.

19. An engine boosting system according to claim 18, further comprising a cooler operable to cool gases in the boost circuit.

20. An engine boosting system according to claim 2, further comprising a cooler operable to cool gases in the boost circuit.
